(19) United States
(12) Patent Application Publication
(10) Pub. No.: US 2022/0333437 A1
(43) Pub. Date: Oct. 20, 2022

(54) SCISSOR-TYPE GUIDE WITH SPRING BIASING AID

(71) Applicant: JØRN KRAB HOLDING KBH APS, Copenhagen K (DK)

(72) Inventors: Svend Erik Paulsen Dahl, Hedehusene (DK); Jakob Blauenfeldt-Dydensborg, Dragør (DK); Jørn Krab Jensen, Copenhagen K (DK)

(21) Appl. No.: 17/640,360

(22) PCT Filed: Sep. 4, 2020
(86) PCT No.: PCT/EP2020/074835

§ 371 Date: Mar. 4, 2022

(30) Foreign Application Priority Data
Sep. 5, 2019 (DK) PA201970555

(51) Int. Cl. E06B 9/302; E06B 9/327

(52) U.S. Cl. CPC E06B 9/302; E06B 9/327

(57) ABSTRACT

A scissor-type guide for guiding extension and retraction of lamellae. The scissor-type guide includes at least two scissor links, each having a first and second scissor members. The guide further includes a first rotational joint formed between the scissor members of each of the scissor links, and two second rotational joints formed between first ends of a first scissor member and a second scissor member of a first scissor link, and respective ones of second ends of a first scissor member and a second scissor member of a neighboring second scissor link. A spring member is formed between the scissor members at a first rotational joint, or between a first scissor member of the first scissor link and the first scissor member of a neighboring second scissor link at a second rotational joint.

The present invention relates to a system for closing an opening. More particularly, the present invention may in certain aspects relate to a blind for selectively limiting or preventing passage of light, sound and/or air through an opening. The opening may be an opening in a building structure, for example a window or door opening or a façade element. The system according to the invention relates to the type having a scissor-type guide, for guiding lamellae between a retracted position, and an extended position. Further, the present invention relates to improvements in scissor-type guides. Scissor-type guides are typically used to guide extension and retraction of lamellae for heavier types of blinds and armored blinds, and the like. The present invention more specifically relates to improving the stability of the scissor-type guide e.g. by raiding retraction or extension of the scissor-type guide. The invention also relates to improving the compactness of scissor-type guides.

### BACKGROUND OF THE INVENTION

Scissor-type guides for guiding lamellae are used e.g. for heavier type of blinds, such as for use on the external side of a building structure, e.g. for regulating light, sound and/or air/gasses into/out of the building structure though openings therein. Such opening may be windows or doors in a wall of the building structure, or overhead lighting openings. They may also be utilized as façade elements, e.g. build into frames on the façade. In such systems, a drive mechanism is used for moving the lamellae between a retracted position, and an extended position (and back). Further, the lamellae may be rotated between an open stat and a closed (shut) state. In use, the scissor-type guide of such blinds have one end, a first end, fixedly mounted to one edge of the opening, while an opposite end (second end) is freely moveable relative to the fixed, first end of the scissor-type guide along a first direction, which is parallel to a plane defined by the opening in which the blind is arranged. Scissor-type guides comprise a plurality of scissor links connected to each other along a first direction. Each scissor-link comprises two elongate link members/scissor members. The two scissor members of a scissor link are rotationally connected to each other in a rotational joint, typically at the middle of the scissor members. The opposed ends of the scissor members of one scissor link, are connected—in rotational joints—to ends of the scissor members of two neighbouring scissor links along the first direction. Further, each scissor link may comprise a tilting arm configured for imparting rotation of the lamellae. It will be understood that the rotation between two rotationally interconnected scissor members of a scissor link defines a plane. Typically, the scissor-type guides are oriented in such a way that this plane is transverse to the plane of the building opening in which the blind is intended to be mounted. Thereby, the scissor-type guide will take up as little space as possible along sides of the opening. However other orientations are conceivable.

Due to the rather complex structure of the scissor-type guide, when such blinds are in the retracted position, even though they are retracted, they take up space at the edge of the opening at which they are mounted. Typically, the larger and heavier the blind, the more space, the blind will consume in retracted position. This is undesirable, since the area covered by the retracted blind is then not available for influx of light or for the passage of persons or goods, etc. Further, the area/space occupied by the retracted blind may be undesirable from an aesthetic point of view.

Therefore, in some cases such blinds or similar systems are hidden in the building structure surrounding the opening (wall, floor or roof). Even though this may hide the blind, it still takes up room that may otherwise have been used for enlarging the opening or for other technical equipment or insulation, etc. Therefore, there is a general need to make the blind, and in particular the scissor-type guide thereof, pack as compact as possible.

Consequently, many scissor-type guides are designed to fold/pack as compact as possible. The primary focus of this effort has been on the main body of the scissor-type guides, i.e. the construction of the scissor links forming the scissor-type guide.

When the scissor-type guide is in retracted position the extent in a direction transverse to the plane of the opening is defined by the length of the scissor members, and the angle at which they may be rotated relative to each other This angle may depend on a number of factors, such as the width of the individual scissor members, the type of rotational joints, etc. In any case, it is desirable that the mount, or first end connection, does not extend beyond the width of the scissor links (when the scissor-type guide is in retraced position), the width being defined by the plane defined by the rotation between scissor members, as described above. At the same type the first end of the scissor-type guide as such, i.e. the scissor link closest to the mount should be brought as close as possible to the edge of the building opening (or the intermediary bracket or rail) to which the scissor-type guide is mounted, taking into consideration also parts (such as tilting arms) configured for rotating the lamellae.

Another problem of the known scissor-type guides is that they may become very long, i.e. they may comprise a large number of scissor links. As each scissor link has a (typically central) first rotational joint and two second rotational joints at each end thereof, and since a little slack is introduced by each rotational joint, the entire structure of a scissor-type guide may become a little unstable in the sense that, when for example the scissor guide is retracted (for retracting the lamellae), the retraction becomes uneven over the length of the partially or fully extended scissor-type guide. This may result in an uneven distribution of the lamella, which is may be aesthetically undesirable-. Further, it may cause parts of the scissor guide to be stuck in the guide track formed in the side rails in which the scissor-type guides are typically arranged.

European patent application EP 2 540 951 A1 discloses a “Venetian” blind having a plurality of “slats” or lamellae whose left end portion cooperates with a lift mechanism in the form of a prior art scissor-type guide, and a tilt mechanism. Independently driven tilt mechanisms at either side allows the lamellae to twist.

### SUMMARY OF THE INVENTION

One or more objects of the invention may—in a first aspect or the invention—be achieved by a scissor-type guide for guiding extension and retraction of lamellae, said scissor-type guide comprising
at least two scissor links, each scissor link comprising a first scissor member and a second scissor member,
a first rotational joint formed between the first and second scissor members of each one of the scissor links, and
two second rotational joints formed between first ends of a first scissor member and a second scissor member of a first scissor link, and respective ones of second ends of a first scissor member and a second scissor member of a neighbouring, second scissor link;

where a spring member is formed between the first scissor member and the second scissor member at a first rotational joint of the scissor-type guide, or between a first scissor member of the first scissor link and the first scissor member of a neighbouring second scissor link at a second rotational joint of the scissor-type guide.

Thereby, is achieved that the scissor-type guide is stabilized. The spring member may aid in the extension or the retraction of the scissor-type guide and thereby the lamellae.

The scissor type guide may as implied above have only two scissor links. However, the scissor type guide may also have more than two scissor links, or more than three, or more than four. The scissor type guide may comprise a plurality of scissor links. The number of scissor links in the scissor-type guide may be adapted to the length the scissor-type guide is intended to cover.

As implied above, a spring member may be arranged at only a single one of the first scissor joints of a scissor-type guide. However, in alternative embodiments, a spring member may be provided at all of the first scissor joints of the scissor-type guide. In yet other embodiments a spring member may be provided at some of the first scissor joints of the scissor-type guide. In some embodiments a spring member may be provided at every second of the first scissor joints of the scissor-type guide. In some embodiments a spring member may be provided at every third of the first scissor joints of the scissor-type guide. In some embodiments a spring member may be provided at fourth of the first scissor joints of the scissor-type guide. In some embodiments a spring member may be provided at every fifth of the first scissor joints of the scissor-type guide. In some embodiments a spring member may be provided at selected first scissor joints at selected positions along the scissor-type guide. For example spring members may be provided at first scissor joints at the first or at the second end of the scissor-type guide.

As also implied above, a spring member may be arranged at only a single one of the second scissor joints of a scissor-type guide. However, in alternative embodiments, a spring member may be provided at all of the second scissor joints of the scissor-type guide. In yet other embodiments a spring member may be provided at some of the second scissor joints of the scissor-type guide. In some embodiments a spring member may be provided at every second of the second scissor joints of the scissor-type guide. In some embodiments a spring member may be provided at every third of the second scissor joints of the scissor-type guide. In some embodiments a spring member may be provided at fourth of the second scissor joints of the scissor-type guide. In some embodiments a spring member may be provided at every fifth of the second scissor joints of the scissor-type guide. In some embodiments a spring member may be provided at selected second scissor joints at selected positions along the scissor-type guide. For example spring members may be provided at second scissor joints at the first or at the second end of the scissor-type guide.

In an embodiment the spring member comprises a coil, a first elongate part having a free end extending from the coil, and a second elongate part having a free end extending from the coil. Preferably, the coil is arranged coaxial with a lamella shaft of the rotational joint with which it is associated. The free end of the first elongate part may be connected to one of the scissor members of the rotational joint, and the free end of the second elongate part is connected to the other of the scissor members.

In an embodiment, the free ends of the first and second elongate parts are connected to the respective scissor members by a portion of the first free end being arranged in an opening in one of the scissor member, and a portion of the second free end being arranged in an opening through the other one of the scissor members.

The openings in the scissor member(s) may be a through-going opening. The openings being through-going, allow a very easy assembly. The portion of the free end of the spring member being connected to the scissor member may—in a simple embodiment be an end portion of the free end being bent such that it may be arranged through the opening. This will allow a particularly simple and cost efficient manufacture.

Further, in some embodiments, the openings may be formed as slits. The slits are preferably arranged in a longitudinal direction of the scissor member (the scissor members being elongate structures, having a longitudinal direction).

The first and the second scissor members of the first scissor link preferably are configured such that they have inner sides facing each other and outer sides facing away from each other. Further, the first scissor member and the second scissor member of the second scissor links preferably have inner sides facing each other and outer sides facing away from each other. Preferably the scissor members are elongate structures, having a longitudinal direction. The scissor members may be elongate plate-like structures. In an embodiment of the scissor-type guide, the outer side of the first scissor member of the first scissor link faces towards the inner side of the first scissor member of the second scissor link, and the second scissor member of the first scissor link faces towards the inner side of the second scissor member of the second scissor link.

Thereby, a scissor-type guide is provided, which at least allows space for a spring member to be provided in connection with the first rotational joints of the second scissor link. Thus a compact scissor-type guide is obtained, which provides improved stability.

In an embodiment, a spring member is arranged between the first scissor member and the second scissor member of at least one first rotational joint of the second scissor link of the scissor-type guide.

As implied above, a spring member may be arranged at only a single one of the first scissor joints of a second scissor link of a scissor-type guide. However, in alternative embodiments, a spring member may be provided at all of the first scissor joints of the second scissor links of the scissor-type guide. In yet other embodiments a spring member may be provided at some of the first scissor joints of the second scissor links of the scissor-type guide. In some embodiments a spring member may be provided at every second of the first scissor joints of the second scissor links of the scissor-type guide. In some embodiments a spring member may be provided at every third of the second scissor links of the first scissor joints of the scissor-type guide. In some embodiments a spring member may be provided at every fourth of the first scissor joints of the second scissor links of the scissor-type guide. In some embodiments a spring member may be provided at every fifth of the first scissor joints of the second scissor links of the scissor-type guide. In some embodiments a spring member may be provided at selected first scissor joints at selected second scissor links along the scissor-type guide. For example spring members may be provided at first scissor joints of the second scissor links at the first or at the second end of the scissor-type guide.

In an embodiment, the spring member comprises
a coil;
a first elongate part having a free end extending from the coil; and
a second elongate part having a free end extending from the coil,
   where said coil is arranged coaxially with a lamella shaft of the first rotational joint of the second scissor link; where the free end of the first elongate part is connected to the first scissor member of the first rotational joint of the second scissor link, and where the free end of the second elongate part is connected to the second scissor member of the first rotational joint of the second scissor link.

In an embodiment, the free end of the first elongate part is connected to the first scissor member of the first rotational joint of the second scissor link by a portion of the free end of the first elongate part being arranged through an opening through said first scissor members; and the free end of the second elongate part is connected to the second scissor member of the first rotational joint of the second scissor link by a portion of the free end of the second elongate part being arranged through an opening through the second scissor member.

The openings in the scissor member(s) may be a through-going opening. The openings being through-going, allow a very easy assembly. The portion of the free end of the spring member being connected to the scissor member may—in a simple embodiment be an end portion of the free end being bent such that it may be arranged through the opening. This will allow a particularly simple and cost efficient manufacture.

Further, in some embodiments, the openings may be formed as slits. The slits are preferably arranged in a longitudinal direction of the scissor member (the scissor members being elongate structures, having a longitudinal direction).

In any of the above described embodiments of a scissor-type guide, the spring member biases the scissor-type guide towards a retracted position.

In a second aspect, the objects of the invention are obtained by a system for closing an opening, the system comprising a scissor type guide according to any of the embodiments of the first aspect of the invention described above.

In a third aspect, the objects of the invention are obtained by a blind for selectively limiting or preventing passage of light, sound and/or air through an opening, the blind comprising a scissor type guide according to any of the embodiments of the first aspect of the invention described above.

In a fourth aspect, the objects of the invention are obtained by a scissor-type guide for guiding extension and retraction of lamellae, said scissor-type guide comprising
at least two scissor links, each scissor link comprising a first scissor member and a second scissor member,
a first rotational joint formed between the first and second scissor members of each one of the scissor links, and
two second rotational joints provided between first ends of a first scissor member and a second scissor member of a first scissor link, and respective ones of second ends of a first scissor member and a second scissor member of a neighbouring, second scissor link,

where the first and the second scissor members of the first scissor link has an inner side facing each other and an outside facing away from each other;

where the first scissor member and the second scissor member of the second scissor links has an inner side facing each other and an outside facing away from each other; and

where the outer side of the first scissor member of the first scissor link faces towards the inner side of the first scissor member of the second scissor link, and the second scissor member of the first scissor link faces towards the inner side of the second scissor member of the second scissor link.

Thereby a particularly compact scissor-type guide is provided. Further, a scissor-type guide is provided, which also allows space for a spring member to be provided in connection with the first rotational joints of the second scissor link. Thus a compact scissor-type guide is obtained, which provides improved stability.

In an embodiment of the fourth aspect, a spring member is arranged between the first scissor member and the second scissor member of at least one first rotational joint of the second scissor link of the scissor-type guide,

As spring member may be arranged at only a single one of the first scissor joints of a second scissor link of a scissor-type guide. However, in alternative embodiments of the fourth aspect, a spring member may be provided at all of the first scissor joints of the second scissor links of the scissor-type guide. In yet other embodiments of the fourth aspect, a spring member may be provided at some of the first scissor joints of the second scissor links of the scissor-type guide. In some embodiments of the fourth aspect, a spring member may be provided at every second of the first scissor joints of the second scissor links of the scissor-type guide. In some embodiments of the fourth aspect, a spring member may be provided at every third of the second scissor links of the first scissor joints of the scissor-type guide. In some embodiments of the fourth aspect, a spring member may be provided at every fourth of the first scissor joints of the second scissor links of the scissor-type guide. In some embodiments of the fourth aspect, a spring member may be provided at every fifth of the first scissor joints of the second scissor links of the scissor-type guide. In some embodiments of the fourth aspect, a spring member may be provided at selected first scissor joints at selected second scissor links along the scissor-type guide. For example spring members may be provided at first scissor joints of the second scissor links at the first or at the second end of the scissor-type guide.

In an embodiment of the fourth aspect, the spring member comprises
a coil;
a first elongate part having a free end extending from the coil; and
a second elongate part having a free end extending from the coil,
   where said coil is arranged coaxially with a lamella shaft of the first rotational joint of the second scissor link; where the free end of the first elongate part is connected to the first scissor member of the first rotational joint of the second scissor link, and where the free end of the second elongate part is connected to the second scissor member of the first rotational joint of the second scissor link.

In an embodiment of the fourth aspect, the free end of the first elongate part is connected to the first scissor member of the first rotational joint of the second scissor link by a portion of the free end of the first elongate part being arranged through an opening through said first scissor members; and the free end of the second elongate part is connected to the second scissor member of the first rotational joint of the second scissor link by a portion of the free end of the second elongate part being arranged through an opening through the second scissor member.

The openings in the scissor member(s) may be a through-going opening. The openings being through-going, allow a very easy assembly. The portion of the free end of the spring member being connected to the scissor member may—in a simple embodiment be an end portion of the free end being bent such that it may be arranged through the opening. This will allow a particularly simple and cost efficient manufacture.

Further, in some embodiments of the fourth aspect, the openings may be formed as slits. The slits are preferably arranged in a longitudinal direction of the scissor member (the scissor members being elongate structures, having a longitudinal direction).

In any of the above described embodiments of a scissor-type guide of the fourth aspect, the spring member biases the scissor-type guide towards a retracted position.

In a fifth aspect, the objects of the invention are obtained by a system for closing an opening, the system comprising a scissor type guide according to any of the embodiments of the fourth aspect of the invention described above.

In a sixth aspect, the objects of the invention are obtained by a blind for selectively limiting or preventing passage of light, sound and/or air through an opening, the blind comprising a scissor type guide according to any of the embodiments of the fourth aspect of the invention described above.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1, in a perspective view, shows a blind with a scissor-type guide according to an embodiment of the invention;

FIG. 2A, in a perspective view, shows a known scissor-type guide for a blind, with the lamellae in an extracted position;

FIG. 2B is a front view of the scissor-type guide of FIG. 2A;

FIG. 2C is a side view of the scissor-type guide of FIG. 2A;

FIG. 2D is a back view of the scissor-type guide with of FIG. 2A;

FIG. 3A, in a perspective view, shows the a scissor-type guide of FIG. 2A with the lamellae in an extended position;

FIG. 3B is a front view of the scissor-type guide of FIG. 3A;

FIG. 3C is a side view of the scissor-type guide of FIG. 3A;

FIG. 3D is a back view of the scissor-type guide of FIG. 3A;

FIG. 4 is a detailed view of a portion of a prior art scissor-type guide;

FIG. 5 is a detailed perspective view of a portion of a scissor-type guide according to the invention; and

FIG. 6, in a perspective see-through view, shows the scissor-type guide of FIG. 5.

### DETAILED DESCRIPTION OF THE EMBODIMENTS

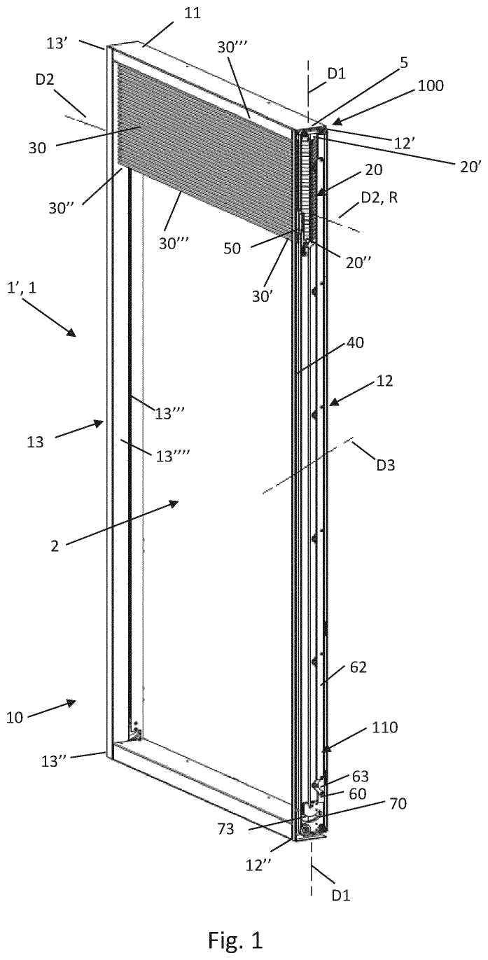

FIG. 1 shows a system 1′, such as a blind 1, for closing an opening 2 of a building structure, according to an aspect of the e invention. The system 1′ comprises a scissor-type guide 20, a set of lamellae 30, and a mount 100 for mounting the scissor-type guide 20 to the building structure. The system 1′ may further comprise a conveyor 40 for operating the scissor-type guide 20, and a tilt system 110 for rotating the lamellae 30. The tilt system 110 may comprise a tilt rail 60 and a tilt bracket 70.

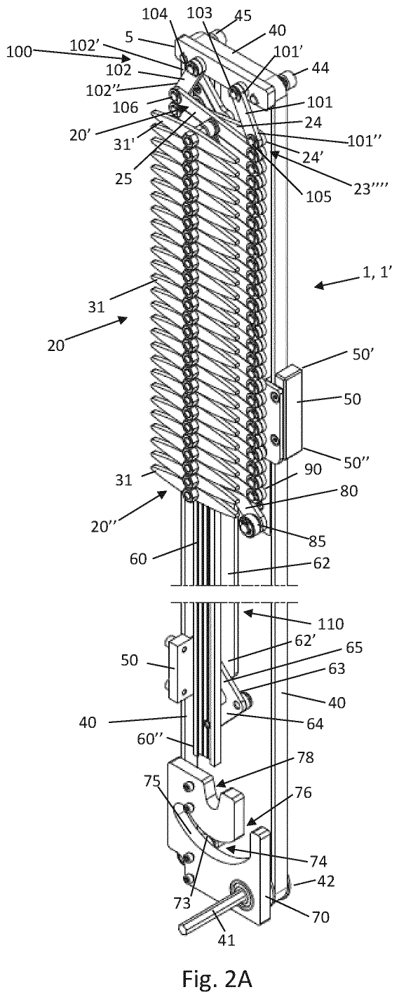

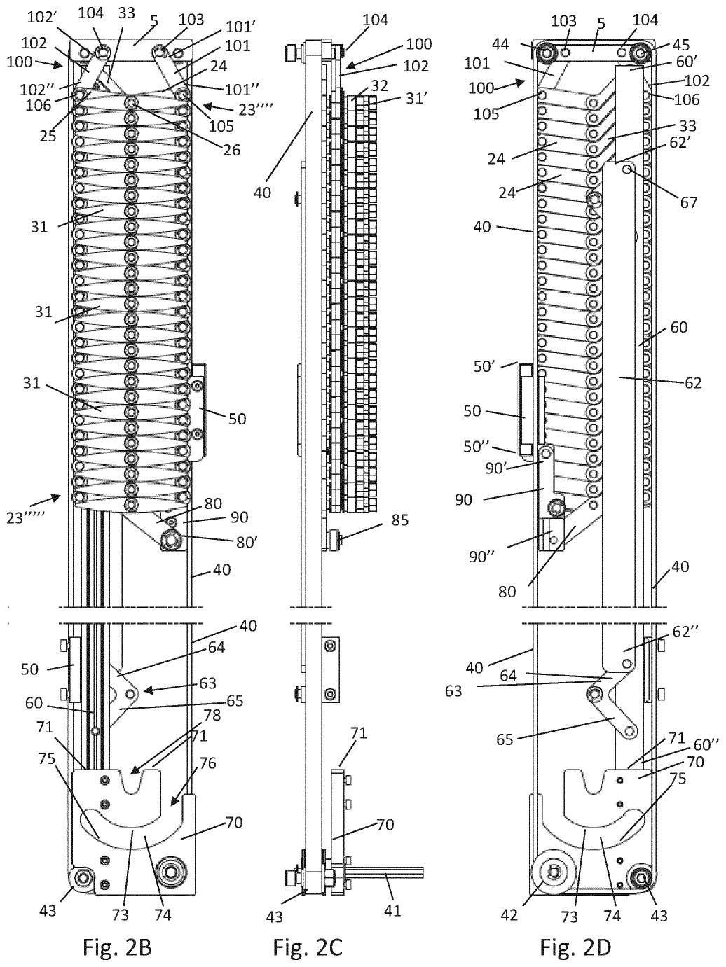

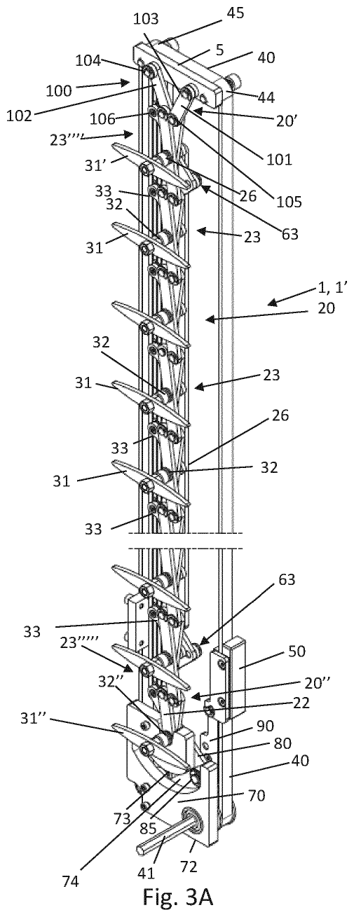

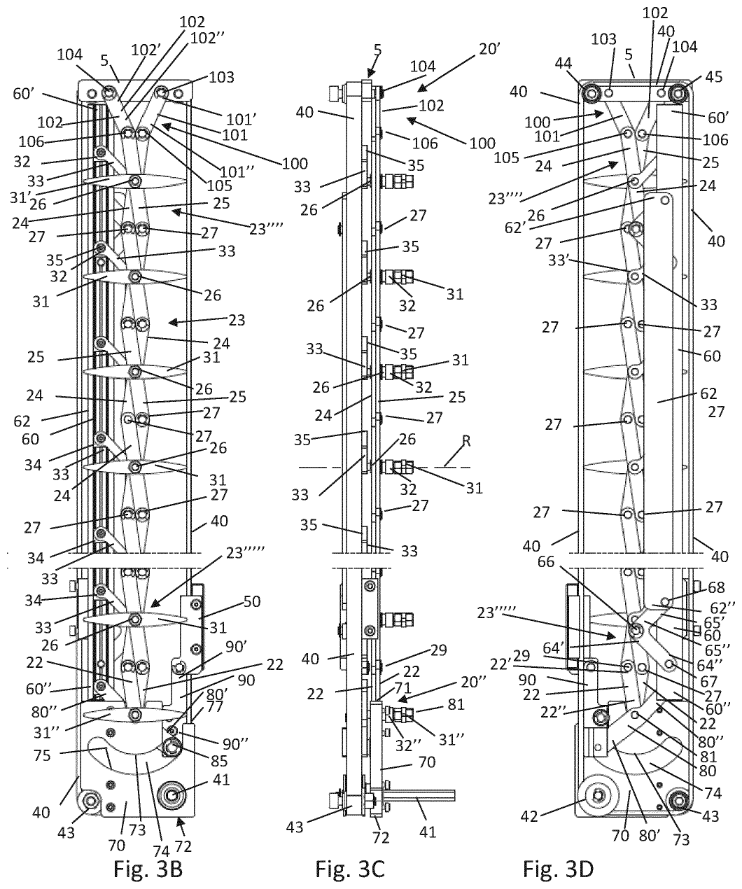

The scissor-type guide 20 is configured for guiding the lamellae 30 along a linear path between a retracted position (se e.g. FIGS. 1 and 2A), and an extended position (See e.g. FIG. 3A). The lamellae 30 are connected to the scissor-type guide 20. The conveyor 40 is configured for driving the scissor-type guide 20, and thereby the lamellae 30 connected thereto—between
the retracted position—as shown in FIG. 1—where all of the lamellae 30 are positioned adjacent to a fixed, first end of 20′ of the scissor-type guide 20—and
the extended position along a first direction D₁.

The first direction D₁ may be defined as a line between the fixed, first end 20′ of the scissor-type guide 20, and a second end 20″ of the scissor-type guide 20, which second end 20″ is moveable relative to the fixed, first end 20′ of the scissor-type guide 20. The fixed, first end 20′ of the scissor-type guide 20 is fixed to the opening of the building structure by the mount 100 according to another aspect of the invention.

In the extended position, the lamellae 30 are spaced apart from each other and distributed along the first direction, D₁, and the moveable or free, second end 20″ of the scissor-type guide 20 has been brought to a position as far as possible away from the fixed first end 20′ of the scissor-type guide 20 in the first direction, D₁. In some embodiments, and in the embodiments shown herein, this position corresponds to one where the second end 20″ of the scissor-type guide 20 is adjacent to a tilt bracket 70, which is spaced apart from the fixed, first end 20′ of the scissor-type guide 20 in the first direction, D₁. An example of lamellae 30 being extended to the fully extended position may be seen in FIG. 3A-D. When the lamellae 30 are in the retracted position, as shown in FIG. 1 or 2A-D, they are brought close to each other, such as in direct contact with each other.

In the shown embodiments, the tilt bracket 70 is arranged at a suitable distance away from the first end 20′ of the scissor-type guide in the first direction D₁. Thus, the first direction D₁ may alternatively be defined by a straight line extending through the fixed, first end 20′ of the scissor-type guide 20 and the tilt bracket 70. The free, second end 22″ of the scissor-type guide 20 is movable along the first direction D₁.

The tilt system 110 comprising the tilt bracket 70 serves the purpose of aiding the tilting/rotation of the lamellae 30 between an open state and a closed state. The present invention may be used with other types of tilt mechanisms.

The system 1′ may be installed in or on a building structure (not shown), e.g. as a façade element or in an opening in the building structure, such as a window opening in a wall or in a roof. The system 1′ is configured to close an opening to or in which is arranged. The closing may be defined as operating/driving the lamellae 30 from the retracted position to extended position. Alternatively, closing may be defined as operating/driving the lamellae 30 from the retracted position to extended position, and turning the lamellae 30 from a state, where planes—defined by generally planar surfaces of the lamellae 30—are parallel to each other (and perpendicular to a plane defined by the opening 2), to a state, where the planes defined by the lamellae 30 are aligned with each other to be oriented in the same plane (or parallel to the plane defined by the opening 2).

In the following, the system 1′ is exemplified by a blind 1 configured for closing an opening 2, such that the lamella 30 can be brought to decrease or prevent light from passing through the opening 2.

In a system 1′/blind 1 according to an embodiment of the invention, the scissor-type guide 20 with the set of lamellae 30, may be connected directly to the building structure, such as to frame parts of a window or door opening, via a mount 100. In such cases, also, the conveyor 40 and the tilt system 110 may be connected directly to the building structure. Alternatively or the blind 1 may further comprise side rails 12, 13, which side rails 12, 13 are then connectable to the building structure. The system 1′/blind 1 may alternatively, or additionally to the side rails 12, 13, comprise first and/or second end members 11, 14, formed, e.g. in a rectangular frame 10. In these cases, the scissor-type guide 20 with the set of lamellae 30 may be connected—via the mount 100—to a side rail 12, 13 and/or the first end member 11. In such cases also, the conveyor 40 and eventually the tilt system 110, may be connected to a side rail and/or an end member 11, 14.

In cases (not shown) where the blind 1 does not comprise side rails or end members, the mount 100 may be fixed to the building structure, e.g. via suitable intermediary brackets.

In the embodiment shown in FIG. 1 the first end 20′ of the scissor-type guide 20 is connected to a first end bracket 5, which in the figure is connected to the first side rail 12. Thus, in this embodiment the mount 100 comprises the first end bracket 5. However, in other (not shown) embodiments a similar first end bracket 5 may be connected directly to the building structure, or to a first end member 11, or to the building structure via an intermediary bracket.

In an embodiment, the blind 1 comprises two side rails, a first side rail 12 and a second side rail 13. The first and second side rails 12, 13 are elongate and arranged in parallel with each other. A scissor-type guide 20 may be arranged at least at the first side rail 12. The first end 20′ of the scissor-type guide 20 may in this case be connected to the first side rail 12. Further, the conveyor 40 may be connected to the first side rail 12. Further, a tilt bracket 70 may be connected to the first side rail 12.

In another embodiment, the blind 1 alternatively comprises two end members, a first end member 11 and a second end member 14. The first and second end member 11, 14 are elongate and arranged in parallel with each other. The first end 20′ of the scissor-type guide 20 may in this case preferably be connected to the first end member 11. The tilt bracket 70 may be connected to the second end member 14. The conveyer 40 may be connected to the first and/or the second end member 11, 14.

Embodiments (not shown), where the blind 1 or system 1′ comprises a first end member 11 only, and no oppositely arranged second end member, are also conceivable. In this case, at least one scissor-type guide 20 is, at its first end 20′ connected to the first end member 11, and a tilt bracket 70 may be connected to the building structure, in which the system 1′/blind 1 is installed.

In a further embodiment, and as shown in FIG. 1, first and second side rails 12, 13, as discussed above, form part of a closed frame 10, the frame 10 further comprising a first end member 11 and a second end member 14.

The first side rail 12 is elongate and has a first end portion 12′ and a second end portion 12″. Likewise, the second side rail 13 is elongate and has a first end portion 13′ and a second end portion 13″. The above mentioned first longitudinal direction D₁, may alternatively be defined by the longitudinal direction of the elongate first or second side rails 12, 13.

In the FIG. 1 embodiment, the first end member 11 is connected to and interconnects the first end portions 12′, 13′ of the first and second rails 12, 13. Likewise the second end member 14 is connected to and interconnects the second end portions 12″, 13″ of the first and second rails 12, 13. The first and second side rails 12, 13 are preferably arranged in parallel, and the first and second end members 11, 14 are preferably arranged in parallel, whereby the frame 10 forms a parallelogram. Preferably, the frame 10 forms a rectangle or a square.

The first end 20′ of the scissor-type guide 20 may be connected via a mount 100 at the first end portion 12′ of the first side rail 12. The scissor-type guide 20 may be connected to the first side rail 12 at the first end portion 12′ thereof, and/or the first end 20′ of the scissor-type guide 20 may be connected to the first end member 11. A tilt bracket 70 is connected at the second end portion 12″ of the first side rail 12. The tilt bracket 70 is either connected to the first side rail 12 at the second end portion 12″ thereof, and/or to the second end member 14.

Similarly, a second scissor-type guide 20 (not visible in the drawings) may have it's first end 20′ fixed—via a mount 100—to the first end 13′ of the second side rail 13 and/or to the first end member 11. A second tilt bracket 70 may in this case be arranged at a second end 13″ of the second side rail 13 opposite to the first end 20′ of the scissor-type guide 20 and be fixed to the second side rail 13 at the second end 13″ thereof and/or to the second end member 14.

The shown blind 1 further comprises a scissor-type guide 20 and a set of lamellae 30. The scissor-type guide 20 guides the lamellae 30 from the retracted position—as shown in FIG. 1—where all of the lamellae 30 are positioned adjacent to the first end 12′, 13′ of the side rails 12, 13, to a fully extended position, where the lamellae 30 are distributed along the length of the side rails 12, 13 in the first longitudinal direction D₁. An example of lamellae 30 being extended to the fully extended position may be seen in FIGS. 3A-D.

The scissor-type guide 20 is—in the embodiment shown in FIG. 1—arranged inside the first side rail 12. Another scissor-type guide 20 may preferably be arranged in the second side rail 13. In the shown embodiment, the side rails 12, 13 are closed structures comprising not only a rack/framework for mounting the scissor-type guide 20 with the lamellae 30, the conveyor 40, the tilt system 100, and possibly other parts of the blind 1/system 1′, but also providing a casing for the parts. However, in other embodiment the first and/or second side rails 12, 13 may form only a rack/framework for mounting the scissor-type guide 20 with the lamellae 30, the conveyor 40, the tilt system 100, etc., i.e. not forming a casing.

As shown in FIG. 1, the side rails 12, 13 and the end members 11, 14 may form casings, encapsulating the component parts, at least to the side of the blind 1, system 1′ facing the opening 2. In FIG. 1 the back side, i.e. the side facing away from the opening 2 is shown without a cover. It is however noted that in other embodiments (not shown), also the side facing away from the opening may comprise a cover.

The system 1′/blind 1 comprises at least two lamellae 30. However, the system 1′/blind 1 may comprise the number of lamellae 30 needed to cover a particular opening 2. Thus, in general, the system 1′/blind 1 according to the invention comprises a plurality of lamella 30. Each lamella 30 is elongate, with a first end 30′ and a second end 30″ opposite to the first end 30′ in a longitudinal direction D₂ of the lamella 30. The lamellae 30 preferably have a flat, e.g. slightly bent plate shaped structure. Each of the lamellae 30 are connected, at least at the first end 30′ thereof to the scissor-type guide 20 associated with the first side rail 12. The second end 30″ of each of the lamellae may be connected to a second scissor guide (not visible) associated with the second side rail 13. However, in other, not shown, embodiments, the second ends 30″ of the lamellae 30 may be connected to a different kind of guide mechanism.

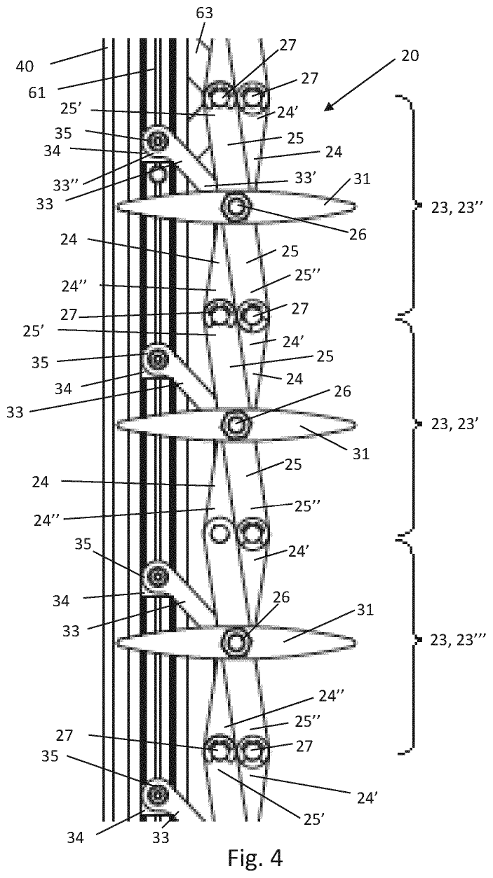

As shown in FIG. 1, the side rail 13 has a slit 13′″ formed in an externally facing surface 13″“, i.e. the side facing the opening 2. The slit 13′″ is elongate and formed along the longitudinal direction of the side rail 13, i.e. the first direction D1. The slit 13′″ is configured, such that lamella shafts 32 (see e.g. FIG. 3A) connected at one, first end 32′ (see e.g. FIG. 3C) of the lamella shaft 32 to the scissor-type guide, may extend there-through, and project from the externally facing surface 13″“, such that a lamella connector 31 (see e.g. FIG. 3A) may be connected to a second end 32′ (see e.g. FIG. 4C) of the lamella shaft 32. The lamella connector 31 is configured for connecting to an end 30′, 30″ of a lamella 30. In FIG. 1, only the externally facing surface 13″″ and the slit 13′″ of the second side rail 13 can be seen. It will however be appreciated that the first side rail 12, may have a corresponding slit 12′″ formed in an externally facing surface 12″″.

The lamella shafts 32 are connected to the scissor-type guide 20 at rotational joints 26 between first and second intersecting scissor members 24, 25 of a scissor link 23, see below. Thereby, the lamella shafts 32 define an axis of rotation, R (see e.g. FIG. 3C, for each lamella, this axis of rotation R is parallel with the longitudinal direction of the lamellae 30, i.e. the second direction D₂.

The first or second side rail 12, 13, or the first or second end members 11, 14 may further function as a cover/housing for a (not shown) drive mechanism, such as an electric motor. The drive mechanism is configured for moving said scissor-type guide and therewith the lamellae 30 between said fully retracted, or open, position shown in FIGS. 1, and 2A-D, to the fully extended position as shown in e.g. FIGS. 3A-D, and further to a closed state (not shown) of the lamellae.

The drive mechanism (not shown) is preferably an electrical motor. However, in other embodiments the drive mechanism may be a mechanical device, for example a winch. In yet other embodiments, the drive mechanism may be a pneumatic or hydraulic device.

In either case, the drive mechanism drives the retraction and extension of the scissor-type guide 20 and thereby the lamellae 30 via the conveyor 40. In the embodiments shown in the figures, the conveyor 40 is an endless band, e.g. a cam belt. The conveyor 40 may be connected to the free, second end 20″ of the scissor-type guide 20 via a follower 50 fixed at a position of the endless belt (conveyor 40) as shown in e.g. FIGS. 1, 2A-D and 3A-D.

As shown in e.g. FIGS. 2A-D and 3A-D, the conveyor 40 in the form of the endless band is conveyed over first end conveyor wheels 44, 45, which are rotationally connected to the first end bracket 5, and over a second end conveyor wheel 43 and a conveyor drive wheel 42, both rotationally connected to a tilt bracket 70. In FIG. 1 the first end bracket 5 is connected to the first end 12′ of the first side rail 12, and the tilt bracket 70 is connected to the second end 12″ of the side rail 12. However, in other (not shown) embodiments, we note that the first end bracket 5 may form part of the first end member 11 and/or the tilt bracket 70 may form part of the second end member 14. We also note that in yet other embodiments, the first end bracket 5 and/or the tilt bracket 70 may be connected directly to a building structure, such as in the frame of a window or a door. In yet other embodiments (not shown), the one or more of the first end conveyor wheels 44, 45 could be connected to another part of the side rail 12 or the first end member 11 than a first end bracket 5. In principle, the first end conveyor wheels 44, 45 could even be connected directly to a building structure, such as in the frame of a window or a door. Likewise, in yet other, not shown embodiments, the second end conveyor wheel 43 and/or the conveyor drive wheel 42, could be connected to another part of the second end 12″ of the side rail 12, or the second end member 14 than a tilt bracket 70. In principle, the second end conveyor wheel 43 and/or the conveyor drive wheel 42 could even be connected directly to a building structure, such as in the frame of a window or a door.

In the embodiment shown in FIG. 1, the conveyor drive wheel 42 is associated with the tilt bracket 70, the second end 12″ of the first side rail 12, or the second end member 14. However, a person skilled in the art would realize that the conveyor drive wheel 42 may alternatively be located at the first end bracket 5, the first end 12′ of the first side rail 12, or the first end member 11, depending on a desired location of the (not shown) drive mechanism. In the embodiment shown in FIG. 1, the (not shown) drive mechanism could preferably be provided in the second end member 14 and be connected to the conveyor drive wheel 42 by a conveyor drive shaft 41, e.g. as shown in FIGS. 3A-D and 4A-D.

In further embodiments, only a single drive wheel 42 is provided at either the first end bracket 5, or the tilt bracket 70. Similar in further not shown embodiments a single first end wheel 44, correspondent to the first end wheels 44, 45 described above, may be provided in the end opposite the single drive wheel 42.

The system 1′/blind 1 may comprise only a single drive mechanism. The single drive mechanism (no shown) may convey the scissor-type guide 20 (and lamellae 30) from the retracted position to the extended position, but also turn the lamellae from an open state to a closed state. However, the scissor-type guide 20 according to the present invention will also function with systems 1′/blinds 1 comprising more than one drive, and with systems 1′/blinds 1 where the extension/retraction of the lamellae 30 and the rotation of the lamellae 30 are individually operational.

It will be appreciated, that instead of an endless band, the conveyor 40 may alternatively comprise an endless chain (not shown). It will also be appreciated, that alternatively, the conveyor 40 may alternatively (not shown) be provided by a limited length band, such as a cam belt, wound on spools at either end. This embodiment would require two drive mechanisms or an additional conveyor in order to provide a two way action. In other, also not shown embodiments instead of an endless belt the scissor-type guide 20 may be retracted and extended by a conveyor 40 in the form of a rotating cam shaft or a telescoping mechanism. In the latter case, the drive mechanism may be incorporated in the conveyor 40 in the form of a linear actuator.

FIGS. 2A-D show a situation where all of the lamellae 30 are gathered in a position adjacent to the first end bracket, i.e. the blind 1 is completely open and not shut. This situation or position corresponds to the position shown in FIG. 1. The lamellae 30 are in the fully retracted position. From e.g. FIG. 2A it may be appreciated that this is obtained by the scissor-type guide 20 being in its fully retracted position, where the free, second end 20″ of the scissor-type guide 20 is brought as close as possible to the fixed, first end 20′ of the scissor-type guide 20. The scissor members 24, 25 (see more below) have—in this position—been packed as close together as possible.

In FIGS. 3A-D the lamellae 30 have been fully extended towards the tilt bracket 70 provided at the second end 12″ of the first side rail 12 and the second end member 14. This position has been obtained by the drive mechanism having driven the follower 50 on the conveyor 40 in the first direction D1, from an initial position adjacent to the first end 12′ of the side rail 12 and adjacent to the fixed, first end 20′ of the scissor-type guide 20 (see e.g. FIG. 1A), and towards the end bracket 70, the follower 50 pushing or dragging the free, second end 20″ of the scissor-type guide 20.

FIGS. 3A-D shows the lamellae 30 in a fully extended position, where the lowermost lamella 30″″ is brought to a position adjacent a tilt bracket 70. It will be appreciated that this position will correspond to a position adjacent to the second end 12″ of the first side rail 12, which is also adjacent to the second end member 14, which cannot be seen in this view in FIGS. 3A-D.

In this position the free, second end 20″ of the scissor-type guide is brought to rest at or in the tilt bracket 70. Preferably, the second end 20″ is in contact with a catch 78, e.g. formed as a notch in an edge of the tilt bracket 70, facing towards the fixed first end 20′ of the scissor guide 20, first edge 71. The lamellae 30 are still in an open position, i.e. the lamellae 30 have not been rotated.

When the scissor-type guide 20 and the lamellae 30 have been brought to the fully extended position, the lamellae 30 may be rotated (or tilted) around the rotational axis R defined by the lamella shaft 32. This rotation may be provided by the tilt system 110. However, this is not shown in the figures.

It will be appreciated that the scissor-type guide 20 according to the invention, may also be utilized in system 1′/blinds 1, where the lamellae 30 are rotatable when the scissor-type guide is not fully extended. Also, it will be appreciated that the scissor-type guide 20 according to the invention may be utilized in system 1′/blinds 1, where the lamellae 30 are not rotatable.

The rotation of the lamellae 30 may be provided by a further movement of the follower 50 in the first direction D₁, from the fixed first end 20′ of the scissor towards the tilt bracket 70, as described in further detail below.

In the following a tilt system 110 suitable for rotating the lamellae will be described. It will however be appreciated that the scissor-type guide 20 according to the invention will work also with other types of tilt systems 110.

Attached to the follower 50 (or connected to the follower via a connector arm 90 is a guide member 85. The guide member 85 may be a knob or cylindrical structure.

The guide member 85 is further connected to a tilt lever 80. The tilt lever 80 is further rotatably connected to the free, second end 20″ of the scissor-type guide 20 in a rotational joint 81, and rotatably and slidably to a tilt rail 60. The tilt rail 60 is elongate and is arranged in the first direction D1, and extends between the fixed, first end 20′ of the scissor-type guide 20 to the oppositely located tilt bracket 70.

The tilt rail 60 is—via tilting arms 33—connected to each of the lamella shafts 32, see e.g. FIG. 4. Thereby, if the tilt rail 60 is translated in a third direction D₃, which is perpendicular to both the first direction D₁ and the second direction D₂ (i.e. the third direction D₃ is perpendicular to a plane defining the opening 2, see e.g. FIG. 1), the tilting arms 33 will cause the lamellae to rotate/tilt.

When the lamellae 30 have been brought to the fully extended position shown in FIGS. 3A-D, the guide member 85 has been brought to a position where it is located at an entrance 76 to curved guide track 74 formed in the tilt bracket 70. The curved guide track 74 is elongate and has a crescent shaped or form and arc, such as an arc of a circle, extending generally in the third direction D₃. The entrance 76 to the guide track 74 is formed in the first direction D₁ through a surface, first surface 71 of the tilt bracket 70, which first surface 71 faces towards the fixed first end 20′ of the scissor-type guide 20 (and the first end bracket 5 (in embodiments where such is present)).

The curved guide track 74 comprises a curved first guide surface 73 formed in/on the tilt bracket 70, the curved first guide surface 73 being convex in the first direction D₁ and facing away from the fixed, first end 20′ of the scissor-type guide 20. The curved guide track 74 further comprises a curved second first guide surface 75 formed in/on the tilt bracket 70, the curved second guide surface 75 being concave in the first direction D1, and facing towards the fixed first end 20′ of the scissor-type guide 20.

When the follower 50 is forced further in the direction of the tilt bracket 70 by the conveyor 40, relative to the position shown in FIGS. 3A-D, the guide member 85 engages into the curved guide track 74, and is guided—at least along the curved first guide surface 73—whereby the guide member 85 is translated generally in the third direction D₃. Since the guide member 85 is connected to one end, first end 80′, of the 80 the tilt lever 80, the tilt lever 80 is forced to rotate around the rotational joint 81. This in turn will translate the tilt rail 60 in the third direction D3, but opposite to the movement of the second guide member 85. As explained above, since the tilt rail 60 is connected to the lamella shafts 32 via the tilting arms 33, the tilting arms 33 will cause the lamellae 30 to rotate/tilt.

Now, with reference to especially FIG. 4, an example of a scissor-type guide 20 will be explained in more detail. We note that scissor-type guides are known in the art.

The scissor-type guide 20 has a first end 20′, see e.g. FIG. 3B, which is intended for fixation to a fixed part of a building structure or to a frame part 11, 12, 13, associated with the system 1′, such as blind 1. In FIGS. 2A-D and 3A-D the first end 20′ of the scissor-type guide 20 is connected to a first end bracket 5, which may be connected directly to the building structure, or as shown in the figures to a frame part of the system 1, such as side rail 12, 13.

The scissor-type guide 20 further comprises a free, second end 20″, opposite the fixed first end 20′, see e.g. FIG. 1. In between the first and second ends 20′, 20″, the scissor-type guide comprises a plurality of scissor links 23 see e.g. FIG. 3B and FIG. 4. The scissor-type guide 20 comprises at least two scissor links 23. Preferably, the scissor-type guide 20 comprises a plurality of scissor links 23. The number of scissor links 23 is adapted to the desired length, that the scissor-type guide 20 is intended to be able to stretch.

Each scissor link 23 comprises two elongate scissor members, a first scissor member 24, and a second scissor member 25, which are rotationally interconnected—like scissors—in a rotational joint 26. The first scissor member 24 is elongate and has a first end 24′ facing toward the first end 20′ of the scissor-type guide 20, a second end 24″ facing away from the first end 20′ of the scissor-type guide 20, and a length L24. Likewise, the second scissor member 25 is elongate and has a first end 25′ facing toward the first end 20′ of the scissor-type guide 20, a second end 25″ facing away from the first end 20′ of the scissor-type guide 20, and a length L25. Preferably, and as shown in the figures, the lengths L24, L25 of the first end second scissor members 24, 25 are equal, L24=L25. In the shown embodiments, the rotational joint 26 between the first and second scissor members 24, 25 of the scissor links, is provided centrally between the first ends 24′, 25′ and the second ends 24″, 25″ of the first and second scissor members 24, 25.

The rotational joint 26 between the first and second scissor members 24, 25 of the scissor links is provided by a portion of a lamella shaft 32 extending through the first and second scissor members 24, 25 of the scissor link 23. The lamella shaft 32 is rotatably connected relative to both the first and the second scissor members 24, 25 of the scissor link 23, but—as also mentioned above fixedly connected to a tilting arm 33 at one end and to a lamella connector 31 at the opposite end.

The ends 24′, 24″, 25′, 25″ of scissor members 24, 25 of one scissor link are rotationally connected to neighbouring scissor links 23. The scissor links 23 are configured for allowing the second end 20″ of the scissor-type guide 20 to be moved away from and towards the first end 20′ in a first direction D₁.

The two scissor members 24, 25 of each of the scissor links 23 are joined in a rotational joint 26 formed centrally on the scissor members 24, 25, i.e. halfway between the first end 24′ and the second end 24″ of the first scissor member 24, and halfway between the first end 25′ and the second end 25″ of the second scissor member 25.

As shown in FIG. 4 the first ends 24′, 25′ of the scissor members 24, 25 of a first scissor link 23′, is—via two rotational joints 27—connected to the second ends 24″, 25″ of the two scissor members 24, 25 of a neighbouring, second scissor link 23″ closer to the first end 20′ of the scissor-type guide 20 along the first direction D₁.

Correspondingly, the second ends 24″, 25″ of the two scissor members 24, 25 of the same, first scissor link 23′ are connected—via rotational links 27 to the first ends 24′, 25′ of the scissor members 24, 25 of a neighbouring, third scissor link 23′″ closer to the second end 20″ of the scissor-type guide 20 along the first direction D₁.

The only exceptions to this are the scissor link 23″″ at the fixed first end 20′ of the scissor-type guide 20, and the scissor link 23′″″ closest to the free, second end 20″ of the scissor-type guide 20. The first ends 24′, 25′ of the scissor members 24, 25 of the scissor link 23″″ at the first end 20′ of the scissor guide 20 are—in the embodiments shown—connected to the above mentioned mount 100. At the second end 20″ of the scissor-type guide 20 the scissor link 23′″″ is connected to a tilt lever 80 via two second end connection members 22.

The two second end connection members 22 are elongate, each having a first end 22′ and an opposite second end 22″, and having a length L22. Preferably, the length L22 of each of the second end connection members 22 is half of the length L24, L25 of the scissor members 24, 25 (L22=½×L24=½×L25). However, in other embodiments (not shown), other lengths may be used.

The second ends 24″, 25″ of the scissor members 24, 25 of the scissor link 23′″″ at the second end 20″ of the scissor guide 20 are connected to the first ends 22′ of the second end connection members 22 in rotational joints 29, see e.g. FIG. 3B-D.

The second ends 22″ of the two second end connecting members 22 are both connected to the tilt lever 80 in the same rotational joint 81. Thus, the two second end connecting members 22 are allowed to rotate relative to the tilt lever 80.

The tilt lever 80 is non-rotatably connected to a lamella shaft 32″. Thus, the tilt lever 80 is configured for rotating the lamella 30″″ closest to the second end 20″ of the scissor guide 20. It will be appreciated that the tilt lever thus replaces the tilting arm 33 in relation to the lamella 30″″ closest to the second end 20″ of the scissor guide 20.

The above described scissor-type guide 20, or another type of scissor-type guide, may be attached/connected/mounted to a building structure, e.g. via a frame part (such as side rail 12, 13 or a first end member 11, or other suitable brackets) by use of a mount 100.

From e.g. comparing FIGS. 3B and 3C it may be appreciated that the first and second scissor members 24, 25 of every one of the scissor links 23 are flat, elongate, plate-like structures. The first scissor member 24 of a scissor link 23 has an inner side facing an inner side of the second scissor member 25, and an outer side facing away from the second scissor member 25 of the same scissor link 23. Correspondingly, the second scissor member 25 has an outer side facing away from the first scissor member 24. Thus, the first scissor member 24 and the second scissor member 25 of the same scissor link 23 have an inner sides facing each other and outer sides facing away from each other.

Now returning to FIG. 4, it can be seen that the first ends 24′, 25′ and the second ends 24″, 25″ of the first and second scissor members 24, 25 of neighbouring scissor links 23, 23′, 23″, 23′″ are connected such that the first end 24′ of the first scissor member 24 of a first scissor link 23′, is—via a rotational joint 27—connected to the second end 24″ of the first scissor member 24 of the neighbouring, second scissor link 23″ (which is closer to the first end 20′ of the scissor-type guide 20 along the first direction D₁), and such that the first end 25′ of the second scissor member 25 of a first scissor link 23′, is—via a rotational joint 27—connected to the second end 25″ of the first scissor member 24 of the neighbouring, second scissor link 23″ (which is closer to the first end 20′ of the scissor-type guide 20 along the first direction D₁).

Correspondingly, the second end 24″ of the first scissor member 24 of the first scissor link 23′, is—via a rotational joint 27—connected to the first end 24′ of the first scissor member 24 of the neighbouring, third scissor link 23′″ (which is closer to the second end 20″ of the scissor-type guide 20 along the first direction D₁). Further, the second end 25″ of the second scissor member 25 of the first scissor link 23′, is—via a rotational joint 27—connected to the first end 25′ of the first scissor member 25 of the neighbouring, third scissor link 23′″ (which is closer to the second end 20″ of the scissor-type guide 20 along the first direction D₁).

It will also be appreciated that the inner side of the first scissor member 24 of the first scissor link 23′ faces towards the inner side of the first scissor member 24 of the second scissor link 23″, and the inner side of the second scissor member 25 of the first scissor link 23′ faces towards the inner side of the second scissor member 25 of the second scissor link 23″.

Correspondingly, be appreciated that the inner side of the first scissor member 24 of the first scissor link 23′ faces towards the inner side of the first scissor member 24 of the third scissor link 23′″, and the inner side of the second scissor member 25 of the first scissor link 23′ faces towards the inner side of the second scissor member 25 of the second scissor link 23′″.

Thus, it will be appreciated that the first and second scissor members 24, 25 of the scissor links 23, such as the first scissor link 23′, second scissor link 23″ and third scissor link 23′″ shown in FIG. 4 may be said to be arranged in two layers.

Further, it will be appreciated that the scissor link 23 structure may be continued beyond the three full scissor links shown in FIG. 4, and the two cut of scissor links shown in the top and bottom of FIG. 4 to form a scissor-type guide 20 with a desired number of scissor links 23.

Now returning to FIG. 4, the figure also shows a tilt rail 60. The tilt rail is also visible in FIGS. 2-3. The tilt rail 60 is elongate, having a first end 61 close to the first end 20″ of the scissor-type guide 20, and a second end 60″ which is in the vicinity of the tilt bracket 70. The tilt rail 60 is connected to the first side rail 12, or to a second side rail 13 or to a framework of the opening 2 in which the blind 1/system 1′ is located. The connection between the tilt rail 60 and the side rail 12, 13 (or the framework of the opening 2) at least allows the entire tilt rail to be translated in the third direction D₃ (see FIG. 1).

A straight, elongate guide track 61 is formed in the tilt rail 60. The straight, elongate guide track 61 preferably extends along the entire length of the tilt rail 60, from the first end of the tilt rail 60 to the second end of the tilt rail 60. The straight, elongate guide track 61 is configured for receiving runners 34. The runners 34 are slidably received in the straight, elongate guide track 61. There is one runner 34 for every lamella 30.

Also visible in FIG. 4 is that for each lamella 30 a tilting arm 33 may be provided. The tilting arm 33 is non-rotatably connected to the lamella shaft 32. The lamella shaft 32 is non-rotatably connected to the lamella connector 31, see e.g. FIG. 3A or FIG. 3C. A lamella 30 may be connected to the lamella connector 31. Each tilting arm 33 is elongate, having a first end 33′ which is non-rotatably to a lamella shaft 32, and a second end 33″ which is connected to a runner 34 in a rotational joint 35.

The tilting arms 33 are configured such that they form an angle of approximately 45° relative to the third direction D₃, when the scissor-type guide 2 is in its retracted position, or in its extended position (and the lamellae 30 have not been tilted), or in a position there in between, where the lamellae 30 have not been tilted.

With regard to the lamella 30″″ closest to the second end 20″ of the scissor guide 20, this lamella 30″″ is not connected to the tilt rail 60 via a tilting arm 33 like the other lamellae 30, but via the tilt lever 80 as mentioned above.

The tilt lever 80 is an elongate structure having a first end 80′ and a second end 80″ opposite to the first end 80′. The above mentioned guide member 85 is attached to the first end 80′ of the tilt lever 80. The rotational joint 81, mentioned above, is preferably arranged at the middle of the tilt lever 80. The lamella 30″″ closest to the second end 20″ of the scissor guide 20 is connected to a lamella connector 31″ closest to the second end 20″ of the scissor guide 20. This lamella connector 31″ is non-rotationally connected to a lamella shaft 32″, which is closest to the second end 20″ of the scissor guide 20. The lamella shaft 32″, which is closest to the second end 20″ of the scissor guide 20, is in turn non-rotationally connected to the tilt lever 80.

The second end 80″ of the tilt lever 80 is connected to a runner 34″ in a rotational joint 35″. The runner 34″ is similar to the runners 34 connected to the tilting arms 33, as described above.

The tilt lever 80 is configured such that it forms an angle of approximately 45° relative to the third direction D₃, when the scissor-type guide 2 is in its retracted position, or in its extended position, or in a position there in between.

When the lamellae 30 are dragged from the retracted position as shown in FIGS. 1, 2A-D, to a the extended position, shown in FIGS. 3A-D (or the reverse direction), the runners 34, 34″ glide/slide in the straight, elongate guide track 61 of the tilt rail 60.

When the tilt rail 60 is translated in the third direction D₃, by the rotation of the tilt lever 80 around lamella shaft 32″, the rotational joints 35, 35″ between the runners 34, 34″ allows the tilt rail to rotate the lamellae 30 via the tilt arms 33 (and the tilt lever 80 with respect to the lamella 30″″).

In principle only a single tilt rail 60 is necessary to tilt or rotate the lamellae 30. However, since the lamellae 30 are connected to the scissor-type guide 20, and scissor-type guides may be unstable for example due to slack in the rotational joints 26, between the scissor members 24, 25 of a scissor link 23, and/or in the rotational joints 27 between the scissor links 23′, 23″, 23′″, it may be necessary to provide stabilisation to the scissor link and the blind 1/system 1′ when translating the tilt rail 60.

FIGS. 1-3 show one embodiment of the scissor guide 20, tilt rail 60, and tilt bracket 70. In this embodiment, the tilt bracket comprises a catch 78 for stabilising the second end 20″ of the scissor-type guide 20. The catch 78 is shown in e.g. FIG. 2A-D. In this embodiment it is formed as a notch in an edge of the tilt bracket 70, facing towards the fixed first end 20′ of the scissor guide 20, first edge 71.

The catch 78 is configured for receiving the lamella shaft 32″ of the second end 20″ of the scissor-type guide 20, which is connected to the tilt lever 80. Thereby, when the lamellae 30 are in the fully extended position, as shown in e.g. FIGS. 3A-D, the lamella haft 32″ is received in the catch 78, whereby movement of the second 20″ of the scissor guide 20 in the third direction D₃ is prevented.

Other ways of forming a catch 78 are conceivable, e.g. by providing protrusions (not shown) on the first edge 71, configured for receiving the lamella shaft 32″ of the second end 20″ of the scissor-type guide 20.

The embodiment shown in FIGS. 1-4 further show one more way of stabilising the scissor-type guide during tilting/rotation of the lamellae 30 by translating the tilt rail 60. In for example FIGS. 2D and 3D it can be seen, that in this embodiment, the system 1′/blind 1 further comprises a tilt member 62.

The tilt member 62 is elongate, and has a first end 62′ extending towards the first end 20′ of the scissor-type guide 20, and a second end 62″ extending towards the second end 20″ of the scissor-type guide 20.

The tilt member 62 is connected to the tilt rail 60 in a parallelogram structure via two or more parallelogram connectors 63. In FIG. 3D, two parallelogram connectors 63 are shown. In the embodiment shown, the parallelogram connectors 63 have two elongate, perpendicularly oriented, arms 64, 65, a first arm 64 and a second arm 65.

The first arm 64 of the parallelogram connector 63 is elongate having a first end 64′ and a second end 64″. The second arm 65 of the parallelogram connector 63 is elongate having a first end 65′ and a second end 65″. The two perpendicularly arranged arms 64, 65 intersect at their first ends 64′, 65′. At the intersection of the two perpendicularly arranged arms 64, 65 a rotational joint 66, rotationally joining the parallelogram connector 63 to the side rail 12 or to the framework surrounding the opening 2 in which the system 1′/blind 1 is arranged. Thereby, the arms 64, 65 of the parallelogram connector 63 may rotate relatively to the side rail 12, 13 and/or the framework.

The first arm 64 of parallelogram connector 63 is configured for connecting to the tilt rail 60. The tilt rail 60 is connected to the second end 64″ of the first arm of the parallelogram connector 63 in a rotational joint 67. Likewise, the second arm 65 of the parallelogram connector 63 is configured for connecting to the tilt member 62. The second end 65″ of the second arm 65 of the parallelogram connector 63 is connected to the tilt member 62 in a rotational joint 68.

It will be appreciated that more than two parallelogram connectors 63 may be provided to connect the tilt rail 60 and the tilt member 62, the further parallelogram connectors 63 being distributed along the lengths of the tilt rail 60 and the tilt member 62.

In another, not shown, embodiment a similar function may be achieved with a parallelogram connector 63 being formed as a triangular plate with the rotational joints 66, 67, 68 provided in each corner (angle).

This parallelogram arrangement ensures that the translation of the tilt rail 60 in the third direction D3 occurs uniformly over the entire length of the tilt rail 60.

As mentioned above, in some embodiments and as shown in all the embodiments in the figures, the follower 50 and the first end 80′ of the tilt lever 80 with the guide member 85 are not directly connected. As shown in e.g. FIG. 3B, the follower 50 and the first end 80′ of the tilt lever 80 may be connected via a connector arm 90.

The connector arm 90 is—in the shown embodiment—a straight, elongate structure, having a first end 90′ and a second end 90″. The first end 90′ of the connector arm 90 is connected to the follower 50 in a rotational joint 91. The second end 90″ of the connector arm 90 is connected to the first end 80′ of the tilt member 80 in a rotational joint 92. This allows the guide member 85 to be translated in the third direction D₃.

The follower 50, may as shown in FIG. 3A-D be an elongate structure, having first end 50′—facing first end 20′ of the scissor-type guide 20, and a second end 50″—facing the tilt bracket 70. Preferably the first end 90′ of the connector arm 90 is connected to the second end 50″ of the follower 50 in a rotational joint 91. Thereby, as the conveyor 40 pulls the follower in the first direction D₁, and towards the tilt bracket 70 in order to bring the lamellae 30 from the retracted position to the extended position, the follower 50 pushes the connector arm 90, the tilt lever 80 and thereby the second end 20″ of the scissor-type guide 20 in the direction of the tilt bracket 70. By thereby pushing the guide member 85 in front of the follower 50, space is allowed for the guide member 85 to engage with the entrance 76 to the curved guide track 74 formed in the tilt bracket 70.

It will be appreciated, that the embodiments of the tilt system 110 etc. shown and described in connection with FIGS. 1-3, and 4 may be located inside side rails 12, 13 as shown in FIG. 1. However, as discussed, they may also be applied without side rails 12, 13.

It will also be realized that the use of the scissor guide and tilt system 110 may be applied either within one or within each side rail 12, 13, or just one at each side (i.e. in systems 1′ without side rails 12, 13). In this case, some lamellae 30 may be connected to scissor-type guide 20 and tilt system 32, 33, 60, 63, 63, 70, 85, 90 in one side and other to the scissor-type guide 20 and tilt system 32, 33, 60, 63, 63, 70, 85, 90 at the other side. For example every other lamella 30 connected at different sides to the tilt system 32, 33, 60, 63, 63, 70, 85, 90, and the other side of the lamella only being rotationally connected to the scissor guide 20.

As discussed above, in some embodiments, where there is a scissor-type guide 20 and tilt system 32, 33, 60, 63, 63, 70, 85, 90 in just one side, the other side of the lamellae 30″, may be provide with another type of guide, allowing uniform extension of the lamellae 30 at both sides 30′ and 30″ thereof.

In general it will be appreciated that instead of a guide track 74 as such with two opposed curved surfaces 73 and 74 may not be necessary. In principle, the curved first guide surface 73 is sufficient for guiding the guide member 85 in order to tilt/rotate the lamellae. The curved second guide surface 75 especially aids in guiding the guide member, when the blind 1 is reversed from the closed state (shut) to the open state.

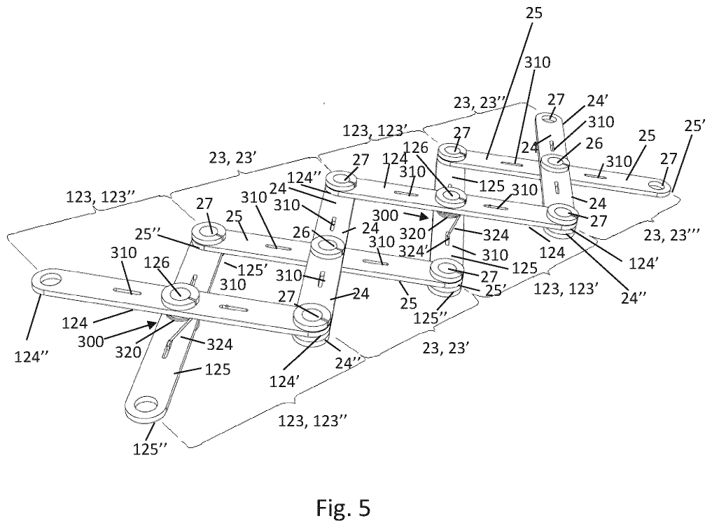

Now turning to FIG. 5, the scissor-type guide 20 according to the invention will be described with reference also to the prior art scissor-type guides 20 as described above. The scissor-type guide 20 is configured for guiding extension and retraction of lamellae 30, of a system 1′ such as a blind 1.

In general, the scissor-type guide 20 according to the invention has basically the same component parts as the scissor-type guide described above. However, some important differences will become apparent from the description below. It is noted that in the following description relative to the description above, like reference numbers will be used for like parts. The scissor-type guide 20 according to the invention and as exemplified in FIG. 5 may in general substitute a scissor-type guide as described above, i.e. it may be connected to a frame 10 or opening 2 of a building structure e.g. via a mount 100 as described above, or it may form part of a system 1′ such as a blind 1 in any of the forms thereof describe above.

The scissor-type guide 20 shown in FIG. 5 comprises four scissor links 23, 123 (only a part of one of the scissor link 123 is depicted in the lower part of the figure). In general the scissor-type guide 20 according to the invention comprises at least two scissor links 23, 123. However, the scissor-type guide may comprise any number of scissor links in order to adapt the length of the scissor-type guide 20 to the size of the opening 2 in which it is to be located. One difference is that the scissor-type guide 20 may comprise a stabilizing biasing mechanism. Another difference between the above described scissor-type guides and the scissor type-guide according to the invention is that the scissor type-guide according to the invention may comprise two different types of scissor links, a first type of scissor links 23 and a second type of scissor links 123 alternating between each other in the direction D₁, as will be described in further detail in the following. The two differences may also be applied advantageously in combination.

However, in common with the prior art scissor-type guides described above, each of scissor links 23, 123 of the scissor-type guide 20 shown in FIG. 20 comprises a first scissor member 24, 124 and a second scissor member 25, 125. More particularly, each of the first type of scissor links 23 comprises a first scissor member 24 and a second scissor member 25, and each of the second type of scissor links 123 comprises a first scissor member 124 and a second scissor member 125.

Further, for each of the scissor links of the first type (first scissor link 23) a first rotational joint 26 is formed between the first and second scissor members (24, 25), and for each of the scissor links of the second type (second scissor link 123) a first rotational joint 126 is formed between the first and second scissor members (124, 125).

Thus, each scissor link 23, 123 comprises two elongate scissor members, a first scissor member 24, 124, and a second scissor member 25, 125, which are rotationally interconnected—like scissors—in a rotational joint 26, 126.

The first scissor member 24 of the first scissor link 23 is elongate and has a first end 24′ facing toward the first end 20′ of the scissor-type guide 20, a second end 24″ facing away from the first end 20′ of the scissor-type guide 20, and a length L24.

Likewise, the second scissor member 25 of the first scissor link 23 is elongate and has a first end 25′ facing toward the first end 20′ of the scissor-type guide 20, a second end 25″ facing away from the first end 20′ of the scissor-type guide 20, and a length L25. Preferably, and as shown in the figures, the lengths L24, L25 of the first end second scissor members 24, 25 are equal, L24=L25. In the shown embodiments, the rotational joint 26 between the first and second scissor members 24, 25 of the scissor links, is provided centrally between the first ends 24′, 25′ and the second ends 24″, 25″ of the first and second scissor members 24, 25, i.e. the two scissor members 24, 25 of each of the first scissor links 23 are joined in a rotational joint 26 formed centrally on the scissor members 24, 25, i.e. halfway between the first end 24′ and the second end 24″ of the first scissor member 24, and halfway between the first end 25′ and the second end 25″ of the second scissor member 25.

The first scissor member 124 of the second scissor link 123 is elongate and has a first end 124′ facing toward the first end 20′ of the scissor-type guide 20, a second end 124″ facing away from the first end 20′ of the scissor-type guide 20, and a length L124. Likewise, the second scissor member 125 of the second scissor link 123 is elongate and has a first end 125′ facing toward the first end 20′ of the scissor-type guide 20, a second end 125″ facing away from the first end 20′ of the scissor-type guide 20, and a length L125. Preferably, and as shown in the figures, the lengths L124, L125 of the first end second scissor members 24, 25 are equal, L124=L125. In the shown embodiment, the rotational joint 126 between the first and second scissor members 124, 125 of the second scissor link 123, is provided centrally between the first ends 124′, 125′ and the second ends 124″, 125″ of the first and second scissor members 124, 125, i.e. the two scissor members 124, 125 of each of the second scissor links 123 are joined in a first rotational joint 126 formed centrally on the scissor members 124, 125, i.e. halfway between the first end 124′ and the second end 124″ of the first scissor member 124, and halfway between the first end 125′ and the second end 125″ of the second scissor member 125.

The first rotational joint 26 between the first and second scissor members 24, 25 of the first scissor link 23 is provided by a portion of a lamella shaft 32 extending through the first and second scissor members 24, 25 of the first scissor link 23. The lamella shaft 32 is rotatably connected relative to both the first and the second scissor members 24, 25 of the first scissor link 23, but—as also mentioned above fixedly connected to a tilting arm 33 at one end and to a lamella connector 31 at the opposite end.

Likewise, the first rotational joint 126 between the first and second scissor members 124, 125 of the second scissor link 123 is provided by a portion of a lamella shaft 32 extending through the first and second scissor members 124, 125 of the second scissor link 123. The lamella shaft 32 is rotatably connected relative to both the first and the second scissor members 124, 125 of the second scissor link 123, but—as also mentioned above fixedly connected to a tilting arm 33 at one end and to a lamella connector 31 at the opposite end.

The ends 24′, 24″, 25′, 25″, 124′, 124″, 125′, 125″ of scissor members 24, 25 124, 125 of one scissor link 23 are rotationally connected to neighbouring scissor links 123. The scissor links 23, 123 are configured for allowing the second end 20″ of the scissor-type guide 20 to be moved away from and towards the first end 20′ in a first direction D₁.

Two second rotational joints 27 are formed between first ends 24′, 25′ of a first scissor member 24 and a second scissor member 25 of a first scissor link 23, and respective ones of the second ends 124″, 125″ of a first scissor member 124 and a second scissor member 125 of a neighbouring, second scissor link 123.

As shown in FIG. 5 the first ends 24′, 25′ of the scissor members 24, 25 of a first scissor link 23′, is—via two rotational joints 27—connected to the second ends 124″, 125″ of the two scissor members 124, 25 of a neighbouring, second scissor link 123′ closer to the first end 20′ of the scissor-type guide 20 along the first direction D₁.

Correspondingly, the second ends 24″, 25″ of the two scissor members 24, 25 of the same, first scissor link 23′ are connected—via rotational links 27 to the first ends 124′, 125′ of the scissor members 124, 125 of a neighbouring, third scissor link 123 closer to the second end 20″ of the scissor-type guide 20 along the first direction D₁. As shown in FIG. 5 the first end 24′ of the first scissor member 24 of a first scissor link 23, 23′, is—via a rotational joint 27—connected to the second end 124″ of the first scissor member 124 of the neighbouring, second scissor link 123, 123′ (which is closer to the first end 20′ of the scissor-type guide 20 along the first direction D₁), and such that the first end 25′ of the second scissor member 25 of a first scissor link 23′, is—via a rotational joint 27—connected to the second end 125″ of the second scissor member 125 of the neighbouring, second scissor link 123′ (which is closer to the first end 20′ of the scissor-type guide 20 along the first direction D₁).

Correspondingly, the second end 24″ of the first scissor member 24 of the first scissor link 23′, is—via a rotational joint 27—connected to the first end 124′ of the first scissor member 24 of the neighbouring, third scissor link 123′″ (which is closer to the second end 20″ of the scissor-type guide 20 along the first direction D₁). Further, the second end 25″ of the second scissor member 25 of the first scissor link 23′, is—via a rotational joint 27—connected to the first end 125′ of the first scissor member 125 of the neighbouring, third scissor link 123′″ (which is closer to the second end 20″ of the scissor-type guide 20 along the first direction D₁).

It will be appreciated that the structure of connected scissor links 23, 123 may be continued beyond the four scissor links shown in FIG. 5 to form a scissor-type guide 20 with a desired number of scissor links 23, 123.

In one aspect, the fourth aspect, of the invention a spring member 300 is formed between the first scissor member 24, 124 and the second scissor member 25, 125 of at least one first rotational joint 26, 126 of the scissor-type guide 20. Alternatively, a spring member 300 may be formed between a first scissor member 24 of the first scissor link 23 and the first scissor member 124 of the second scissor link 123 of at least one second rotational joint 27 of the scissor-type guide 20. Alternatively, a spring member 300 may be formed between a second scissor member 25 of the first scissor link 23 and the second scissor member 125 of the second scissor link 123 of at least one second rotational joint 27 of the scissor-type guide 20.

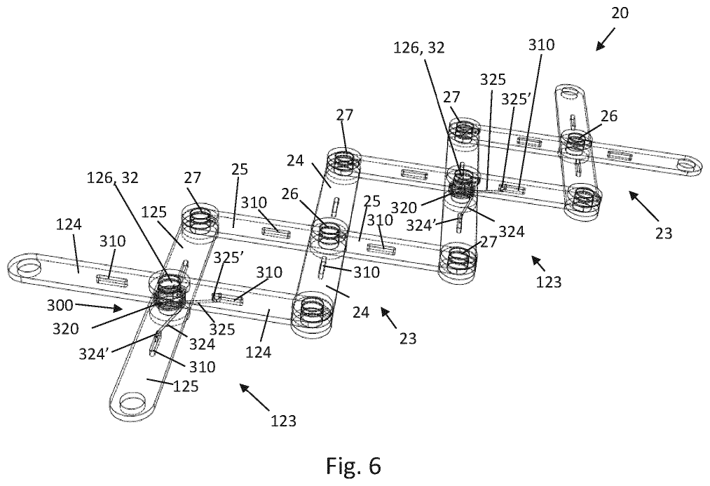

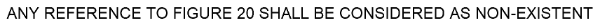

In FIGS. 5 and 6 this aspect is illustrated by a spring member 300 being arranged between the first scissor member 124 and the second scissor member 125 of the above mentioned second scissor link 123′ at the first rotational joint 126 thereof, and another spring member 300 being arranged between the first scissor member 124 and the second scissor member 125 of the above mentioned third scissor link 123″ at the first rotational joint 126 thereof.

Thus, in FIG. 5 spring members 300 are arranged in the scissor links of the second type (second scissor link 123), and in connection with the first rotational joint 126 thereof. However, it will be understood that in other embodiments a spring member 300 may be located in scissor links of the first type (first second scissor link 123), and in connection with the first rotational joint thereof. It will also be understood that in yet other embodiments a spring member 300 may be located between scissor links 23, 123, in connection with a second rotational joint 27 thereof. A spring member may be provided in connection with one of the two rotational joints 27 between the scissor links 23, 123, or one spring member may be provided at each of the two rotational joints 27 between the scissor links 23, 123.

In principle a spring member 300 may also be provided in connection with any of the similar rotational joints, first rotational joints 26 or second rotational joints 27, of the scissor-type guide 20 as described in connection FIG. 2-4 above.

In the embodiment shown in FIGS. 5 and 6 the spring member 300 comprises a coil 320. Preferably, the coil 320 is arranged coaxial with a lamella shaft 32 of the rotational joint 26, 126, 27 with which it is associated. The coil 320 may be wound on a portion of the lamella shaft 32. The coil 320 further comprises a first elongate part 324 having a free end 324′, the first elongate part 324 extending from the coil 320 as such, and a second elongate part 325 having a free end 325′, the second elongate part 325 extending from the coil 320 as such. The free end 324′ of the first elongate part may be connected to one of the scissor members joined in the rotational joint 26, 126, 27 in question, and the free end 325′ of the second elongate part 325 is connected to the other of the two scissor members joined in the rotational joint 26, 126, 27 in question.

The free ends 324′, 325′ of the first and second elongate parts 324, 325 may—as shown—be connected to the respective scissor members by a portion of the first free end 324′ being arranged in an opening 310 in the scissor member, and a portion of the second free end 325′ being arranged in an opening 310 through the other one of the two scissor members of the rotational joint 26, 126, 27.

The opening 310 in the scissor member may be a through-going opening. The openings 310 being through-going, allow a very easy assembly. The portion of the free end of the spring member being connected to the scissor member may—in a simple embodiment be an end portion of the free end 324′, 325′ being bent such that it may be arranged through the opening. This will allow a particularly simple and cost efficient manufacture.

Further, in some embodiments, the openings may—as shown—be formed as slits. The slits are preferably arranged in a longitudinal direction of the scissor member (the scissor members being elongate structures, having a longitudinal direction). The end portion of the free end 324′, 325′ of the spring member 300 may be slideably arranged in the slit.

Further, from FIG. 5 it will be appreciated that the first and second scissor members 24, 25, 124, 125 of every one of the first and second scissor links 23, 123 may be flat, elongate, plate-like structures.

The first and second scissor members 24, 25 of every one of the first scissor links 23 may be identical in shape and dimension. Also, the first and second scissor members 124, 125 of every one of the second scissor links 123 may be identical in shape and dimension. Further the shape and dimension of the scissor members of the first scissor links and the scissor members of the second scissor links may be identical. In any case, the first scissor member 24 of a first scissor link 23 has an inner side facing an inner side of the second scissor member 25 of the same first scissor link 23, and an outer side facing away from the second scissor member 25 of the same scissor link 23. Consequently, the second scissor member 25 of the same scissor link 23 has an outer side facing away from the first scissor member 24 of the same scissor link. Likewise, the first scissor member 124 of a second scissor link 123 has an inner side facing an inner side of the second scissor member 125 of the same second scissor link 123, and an outer side facing away from the second scissor member 125 of the same second scissor link 123. Consequently, the second scissor member 125 of the same second scissor link 123 has an outer side facing away from the first scissor member 124 of the same second scissor link 123.

Thus, the first scissor member 24, 124 and the second scissor member 25, 125 of the same scissor link 23, 123 have an inner sides facing each other and outer sides facing away from each other.

In the scissor-type guide shown in FIG. 4, the inner side of the first scissor member 24 of the first scissor link 23′ faces towards the inner side of the first scissor member 24 of the second scissor link 23″, and the inner side of the second scissor member 25 of the first scissor link 23′ faces towards the inner side of the second scissor member 25 of the second scissor link 23″. As mentioned above, the spring member 13 may be arranged in this type of scissor-type guide. However, in the scissor-type guide 20 shown in FIG. 5, the scissor links 23 and 123 are arranged differently relative to each other than in the scissor-type guide of FIG. 4.

As shown in FIG. 5, the outer side of the first scissor member 24 of the first scissor link 23 faces towards the inner side of the first scissor member 124 of the second scissor link 123, and the second scissor member 25 of the first scissor link 23 faces towards the inner side of the second scissor member 125 of the second scissor link 123.

Preferably, every other scissor link is a first scissor link and every other scissor link of the scissor type guide 20 is a second scissor link 123. Thereby, the first and second scissor members 24, 25 of the first scissor links 23, and the first and second scissor members 124, 125 of the second scissor links 123 are arranged in four separate layers (in the D₂ direction). In every other scissor link (second scissor links 123) of a scissor guide 20 formed in this way the two innermost layers a not “used”/occupied by scissor members, and in the intermediate scissor links (the first scissor links) the outermost layers are no “used”/occupied by scissor members.

Thereby, a scissor-type guide 20 is provided, which at least allows space for a spring member to be provided in connection with the first rotational joints 126 of the second scissor link. Thus a compact scissor-type guide is obtained, which provides improved stability.

As shown in FIG. 5, in an embodiment, a spring member 300 is arranged between the first scissor member 124 and the second scissor member 125 of at least one first rotational joint 126 of the second scissor link of the scissor-type guide. The spring member 300 may be of the kind described above. More particularly, the spring member 300 comprises
a coil 320;
a first elongate part 324 having a free end 324′ extending from the coil 320; and
a second elongate part 325 having a free end 325′ extending from the coil 320,
   where the coil 320 is arranged coaxially with a lamella shaft 32 of the first rotational joint 126 of the second scissor link 123; where the free end 324′ of the first elongate part 324 is connected to the first scissor member 124 of the first rotational joint 126 of the second scissor link 123, and where the free end 325′ of the second elongate part 325 is connected to the second scissor member 125 of the first rotational joint of 126 the second scissor link 123.

As shown in FIG. 5 the first ends 24′, 25′ of the first and second scissor members 24, 25 of a first scissor link 23, is—via two rotational joints 27—connected to the second ends 124″, 125″ of the two scissor members 124, 125 of a neighbouring, second scissor link 123 closer to the first end 20′ of the scissor-type guide 20 along the first direction D₁.

Correspondingly, the second ends 24″, 25″ of the two scissor members 24, 25 of the same, first scissor link 23 are connected—via two rotational links 27 to the first ends 124′, 125′ of the scissor members 124, 125 of a neighbouring, other second scissor link 123′ closer to the second end 20″ of the scissor-type guide 20 along the first direction D₁.

As implied above, a spring member 300 may be arranged at only a single one of the first scissor joints 126 of a second scissor link 123 of a scissor-type guide 20. However, in alternative embodiments, a spring member 300 may be provided at all of the first scissor joints 126 of the second scissor links 123 of the scissor-type guide 20. In yet other embodiments a spring member 300 may be provided at selected ones of the first scissor joints 126 of the second scissor links 123 of the scissor-type guide.

As shown in FIG. 5, in some embodiments, only the second scissor links 126 may be provided with a spring members 300, and no spring members 300 are provided in between the first and second scissor members 24, 25 of the first scissor links 23, and no spring members are provided between the first scissor links 23 and the second scissor links 123, i.e. in connection with the second rotational joints 27. Thereby, a very compact scissor type guide 20 is provided. However, in other—not shown embodiments—it is conceivable that some of the first scissor links 23 are provided with spring members 300. Also, in other—not shown embodiments—it is conceivable that spring members may be provided between the first and second scissor links 23, 123, i.e. in connection with the second rotational joints 27.

Preferably, in any of the above described embodiments of the scissor-type guide 20 according to the invention, the spring member 300 is configured to bias the scissor-type guide 20 towards a retracted position.

It is noted that, in a second aspect, the invention also concerns a system 1′ for closing an opening 2, the system 1′ comprising a scissor type guide according to any of the embodiments of the first aspect of the invention described above. Other features of the system 1′ may be as described in connection with FIGS. 1-4 above.

It is also noted that, in a third aspect, the invention may concern a blind 1, such as for selectively limiting or preventing passage of light, sound and/or air through an opening 2, where the blind 1 comprises scissor type guide 20 according to any of the embodiments of the first aspect of the invention described above. Other features of the blind 1 may be as described in connection with FIGS. 1-4 above. The blind 1 may form part of a system 1′ as in the second aspect.

FIG. 5 also illustrates a fourth aspect of the invention. According to this aspect, a scissor-type guide for guiding extension and retraction of lamellae comprises
at least two scissor links 23, 123, each scissor link 23, 123 comprising a first scissor member 24, 124 and a second scissor member 25, 125,
a first rotational joint 26, 126 formed between the first and second scissor 24, 25; 124, 125 members of each one of the scissor links 23, 123, and
two second rotational joints 27 provided between the first ends 24′, 25′ of a first scissor member 24 and a second scissor member 24 of a first scissor link 23, and respective ones of second ends 124′, 125′ of a first scissor member 124 and a second scissor member 125 of a neighbouring, second scissor link 123,

where both of the first and the second scissor members 24, 25 of the first scissor link 23 has an inner side facing each other, and an outside facing away from each other;

where both of the first scissor member 124 and the second scissor member 125 of the second scissor link 123 has an inner side facing each other and an outside facing away from each other; and

where the outer side of the first scissor member 24 of the first scissor link 23 faces towards the inner side of the first scissor member 124 of the second scissor link 123 and the second scissor member 25 of the first scissor link 23 faces towards the inner side of the second scissor member 125 of the second scissor link 123.

Thereby a particularly compact scissor-type guide 20 is provided. Further, a scissor-type guide is provided, which also allows space for a spring member to be provided in connection with the first rotational joints of the second scissor link. Thus a compact scissor-type guide is obtained, which provides improved stability.

In an embodiment of the fourth aspect, a spring member is arranged between the first scissor member and the second scissor member of at least one first rotational joint of the second scissor link of the scissor-type guide. The first and second scissor member 24, 25; 124, 124 of the first and second scissor links 23, 123, and rotational joints 26, 126, 27 may be as described above in connection with the first aspect of the invention.

As was the case in connection with the first aspect of the invention, in an embodiment of the fourth aspect of the invention, the scissor-type guide 20 may comprise spring members in the same manner as in connection with the first aspect.

In any of the above described embodiments of a scissor-type guide 20 of the fourth aspect, where the scissor type guide 20 comprises one or more spring members 300, the spring members 300 may preferably be configured to bias the scissor-type guide 20 towards a retracted position.

It is noted that, in a fifth aspect of the invention is concerned with a system 1′ for closing an opening 2, the system 1′comprising a scissor type guide 20 according to any of the embodiments of the fourth aspect of the invention described above. Other features of the system 1′ may be as described in connection with FIGS. 1-4 above.

It is also noted that, in a sixth aspect, the invention may concern a blind 1, such as for selectively limiting or preventing passage of light, sound and/or air through an opening 2, where the blind comprises a scissor type guide 20 according to any of the embodiments of the fourth aspect of the invention described above. Other features of the blind 1 may be as described in connection with FIGS. 1-4 above. The blind 1 may form part of a system 1′ as in the second aspect.

It is to be noted that the figures and the above description have shown the example embodiments in a simple and schematic manner. Many of the specific mechanical details have not been shown since the person skilled in the art should be familiar with these details and they would just unnecessarily complicate this description.

### PARTS LIST

D₁ first direction, longitudinal direction of first side rail and direction of movement of scissor-type guide and lamellae
D₂ second direction, longitudinal direction of lamella
D₃ third direction
R rotational axis of lamellae
1′ System for closing an opening
1 blind
2 opening
5 first end bracket
10 frame
11 first end member of frame
12 first side rail
12′ first end portion of first side rail
12″ second end portion of first side rail
13 second side rail
13′ first end portion of second side rail
13″ second end portion of second side rail
13′″ slit formed through an externally facing surface of the second side rail
13″″ externally facing surface of the second side rail
14 second end member
20 scissor-type guide
20′ first end of scissor-type guide
20″ free end of scissor-type guide
22 second end connection member
22′ first end of second end connection member
22″ second end of second end connection member
23 scissor link; first scissor link
23′ first scissor link
23″ second scissor link
23′″ third scissor link
23″″ scissor link closest to the first end of the scissor guide
23′″″ scissor link closest to the second end of the scissor guide
24 elongate, first scissor member
24′ first end of first scissor member
24″ second end of first scissor member
25 elongate, second scissor member
25′ first end of second member
25″ second end of second scissor member
26 rotational joint between first and second scissor members of a scissor link
27 rotational joint between first and second scissor members of neighbouring scissor links
29 rotational joint between the first ends 22′ of the second end connection members 22 and the scissor members 24, 25 of the scissor link 23 at the second end 20″ of the scissor type guide 20
30 lamella
30′ first end of lamella
30″ second end of lamella
30′″lamella closest to the first end of the scissor guide
30″″ lamella closest to the second end of the scissor guide
31 lamella connector
32 lamella shaft
32″ lamella shaft at the second end of the scissor-type guide
33 tilting arm
33′ first end of tilting arm
33″ second end of tilting arm
34 runner
35 rotational joint between runner 34 and second end of tilting arm
40 conveyor
41 conveyor drive shaft
42 conveyor drive wheel
43 second end conveyor wheel on tilt bracket
44 first end conveyor wheel
44′ singular first end conveyor wheel
45 first end conveyor wheel
50 follower
50′ first end of the follower—facing first end of the scissor-type guide
50″ second end of the follower—facing the tilt bracket
60 tilt rail
60′ first (upper, top) end of tilt rail
60″ second (lower, bottom) end of tilt rail
61 elongate guide track in tilt rail
62 tilt member
63 parallelogram connector
64 first arm of parallelogram connector (connecting to tilt rail)
64′ first end of first arm of parallelogram connector
64″ second end of first arm of parallelogram connector
65 second arm of parallelogram connector (connecting to tilt member)
65′ first end of second arm of parallelogram connector
65″ second end of second arm of parallelogram connector
66 rotational joint connecting parallelogram connector to side rail or framework
67 rotational joint between tilt rail and second end of first arm of parallelogram connector
68 rotational joint between tilt member and second end of second arm of parallelogram connector
70 tilt bracket
71 first edge of tilt bracket
72 second edge of tilt bracket
73 curved first guide surface formed in/on the tilt bracket
74 curved guide track formed in the tilt bracket
75 curved second guide surface formed in the tilt bracket
76 entrance to curved guide track formed in the tilt bracket
77 third edge of tilt bracket
78 catch formed in the first edge of tilt bracket
80 tilt lever
80′ first end of tilt lever
80″ second end of tilt lever
81 rotational joint between the second ends 22″ of the second end connection members 22, i.e. the second end 20″ of the scissor type guide 20, and the tilt lever 80.
85 guide member formed at the first end of the tilt lever 80
86 rotational and slideable joint between the second end of the tilt lever 80 and the tilt rail 60
90 connector arm
90′ first end of connector arm
90″ second end of connector arm
91 rotational joint connecting the first end of the connector arm and the follower
92 rotational joint connecting the second end of the connector arm and the tilt lever
100 mount
101 first mount member
101′ first end of first mount member
101″ second end of first mount connection member
102 second mount member
102′ first end of second mount member
102″ second end of second mount connection member
103 first rotational mount joint between the first end 101′ of the first mount members 101 and first end bracket 5
104 second rotational mount joint between the first end 102′ of the second mount member 101 and first end bracket 5
105 rotational joint between the second end 101 of the first mount member 101 and the first scissor member 24 of the scissor link 23 at the first end 20′ of the scissor type guide 20
106 rotational joint between the second end 102 of the second mount member 102 and the second scissor member 25 of the scissor link 23 at the first end 20′ of the scissor type guide 20
110 tilt system
123 second scissor link, scissor link of a second type
124 elongate, first scissor member of a second scissor link
124′ first end of first scissor member of a second scissor link
124″ second end of first scissor member of a second scissor link
125 elongate, second scissor member of a second scissor link
125′ first end of second member of a second scissor link
125″ second end of second scissor member of a second scissor link
126 rotational joint between first and second scissor members of a second scissor link
300 spring member
310 opening in scissor member
320 coil, spring coil
324 first elongate part of coil
324′ free end of first elongate part of coil
325 second elongate part of coil
325′ free end of second elongate part of coil

1. A scissor-type guide for guiding extension and retraction of lamellae, said scissor-type guide comprising
at least two scissor links, each scissor link comprising a first scissor member and a second scissor member,
a first rotational joint formed between the first and second scissor members of each one of the scissor links, and
two second rotational joints formed between first ends of a first scissor member and a second scissor member of a first scissor link, and respective ones of second ends of a first scissor member and a second scissor member of a neighbouring, second scissor link;
wherein a spring member is formed between the first scissor member and the second scissor member at a first rotational joint of the scissor-type guide, or between a first scissor member of the first scissor link and the first scissor member of a neighbouring second scissor link at a second rotational joint of the scissor-type guide.

2. A scissor-type guide according to claim 1, wherein the spring member comprises
a coil;
a first elongate part having a free end extending from the coil; and
a second elongate part having a free end extending from the coil,
wherein said coil is arranged coaxial with a lamella shaft of the rotational joint with which it is associated,
wherein the free end of the first elongate part is connected to one of the scissor members of the rotational joint, and
wherein the free end of the second elongate part is connected to the other of the scissor members.

3. A scissor-type guide according to claim 2, wherein the free ends of the first and second elongate parts are connected to the respective scissor members by a portion of the first free end being arranged through an opening through the one of the scissor member and a portion of the second free end being arranged through an opening through the other one of the scissor members.

4. A scissor-type guide according to claim 1,
wherein the first and the second scissor members of the first scissor link have inner sides facing each other and outer sides facing away from each other;
wherein the first scissor member and the second scissor member of the second scissor links have inner sides facing each other and outer sides facing away from each other; and
wherein the outer side of the first scissor member of the first scissor link faces towards the inner side of the first scissor member of the second scissor link, and the second scissor member of the first scissor link faces towards the inner side of the second scissor member of the second scissor link.

5. A scissor-type guide according to claim 4, wherein the spring member is provided between the first scissor member and the second scissor member of at least one first rotational joint of the second scissor link of the scissor-type guide,

6. A scissor-type guide according to claim 5, wherein the spring member comprises
a coil;
a first elongate part having a free end extending from the coil; and
a second elongate part having a free end extending from the coil,
wherein said coil is arranged coaxially with a lamella shaft of the first rotational joint of the second scissor link;
wherein the free end of the first elongate part is connected to the first scissor member of the first rotational joint of the second scissor link, and
wherein the free end of the second elongate part is connected to the second scissor member of the first rotational joint of the second scissor link.

7. A scissor-type guide according to claim 6,
wherein the free end of the first elongate part is connected to the first scissor member of the first rotational joint of the second scissor link by a portion of the free end of the first elongate part being arranged through an opening through said first scissor members; and
wherein the free ends of the second elongate part is connected to the second scissor member of the first rotational joint of the second scissor link by a portion of the free end of the second elongate part being arranged through an opening through the second scissor member.

8. A scissor-type guide according to claim 7,
wherein the openings are configured as slits arranged in a longitudinal direction of the scissor member.

9. A scissor-type guide according to claim 1, wherein the spring member biases the scissor-type guide towards a retracted position.

10. A scissor-type guide for guiding extension and retraction of lamellae, said scissor-type guide comprising
at least two scissor links, each scissor link comprising a first scissor member and a second scissor member,
a first rotational joint formed between the first and second scissor members of each one of the scissor links, and
two second rotational joints formed between first ends of a first scissor member and a second scissor member of a first scissor link, and respective ones of second ends of a first scissor member and a second scissor member of a neighbouring, second scissor link,
wherein the first and the second scissor members of the first scissor link has an inner side facing each other and an outside facing away from each other;
wherein the first scissor member and the second scissor member of the second scissor links has an inner side facing each other and an outside facing away from each other; and
wherein the outer side of the first scissor member of the first scissor link faces towards the inner side of the first scissor member of the second scissor link, and the second scissor member of the first scissor link faces towards the inner side of the second scissor member of the second scissor link.
